(19) United States
(12) Patent Application Publication
(10) Pub. No.: US 2008/0112018 A1
(43) Pub. Date: May 15, 2008

(54) SHEET PROCESSING DEVICE, IMAGE FORMING APPARATUS, AND SHEET PROCESSING METHOD

(75) Inventor: Ryuichi SATO, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD, Tokyo (JP)

(21) Appl. No.: 11/938,544

(22) Filed: Nov. 12, 2007

(30) Foreign Application Priority Data
Nov. 14, 2006 (JP) 2006-308166

(51) Int. Cl. H04N 1/32

(52) U.S. Cl. 358/468

(57) ABSTRACT

A sheet processing device includes: a sheet processing tool that generates piece-like sheet wastes by processing for sheets; and a sheet waste housing device that houses sheet wastes generated by the sheet processing tool, the sheet waste housing device including: a waste receiver that is provided freely movably between a setting position where the sheet wastes are received and a non-setting position where the sheet wastes received at the setting position are disposed of; and an auxiliary waste receiver that is temporarily located at an auxiliary setting position where the sheet wastes is received in place of the waste receiver under the condition that the waste receiver has been moved from the setting position, and that retreats from the auxiliary setting position under the condition that the waste receiver is located at the setting position.

### CROSS-REFERENCE TO RELATED APPLICATIONS

This application is based on and claims priority under 35 U.S.C. 119 from Japanese Patent Application No. 2006-308166 filed Nov. 14, 2006.

### BACKGROUND

1. Technical Field

This invention relates to a sheet processing device which is employed in an image forming apparatus such as a copying machine or printer, and more particularly to a sheet processing device having a sheet processing tool generating sheet wastes and an image forming apparatus using it.

2. Related Art

In recent years, with development of “on-demand publishing”, has been widely used the image forming apparatus such as an “in-line type” of copying machine or printer having a center-binding or center-folding function and a cutting function for making a booklet in addition to an image forming function.

Such an image forming apparatus is provided with a cutting device serving as a sheet processing device generating sheet wastes. The cutting device performs a cutting function for finishing so that the edge of a bundle of sheets made in a booklet shape, which has been center-folded after being center-bound, is aligned finely. The sheet wastes generated owing to cutting are taken in a waste receiver (housing vessel) within the cutting device, and appropriately disposed.

### SUMMARY

According to an aspect of the present invention, a sheet processing device includes: a sheet processing tool that generates piece-like sheet wastes by processing for sheets; and a sheet waste receiving device that receives sheet wastes generated by the sheet processing tool, the sheet waste receiving device including: a waste receiver that is provided freely movably between a setting position where the sheet wastes are received and a non-setting position where the sheet wastes received at the setting position are disposed of; and an auxiliary waste receiver that is temporarily located at an auxiliary setting position where the sheet wastes is received in place of the waste receiver under the condition that the waste receiver has been moved from the setting position, and that retreats from the auxiliary setting position under the condition that the waste receiver is located at the setting position.

### BRIEF DESCRIPTION OF THE DRAWINGS

Exemplary embodiment of the present invention will be described in detail based on the following figures, wherein:

FIGS. 1A and 1B are views for explaining the schematic configuration of a sheet waste processing device according to this invention;

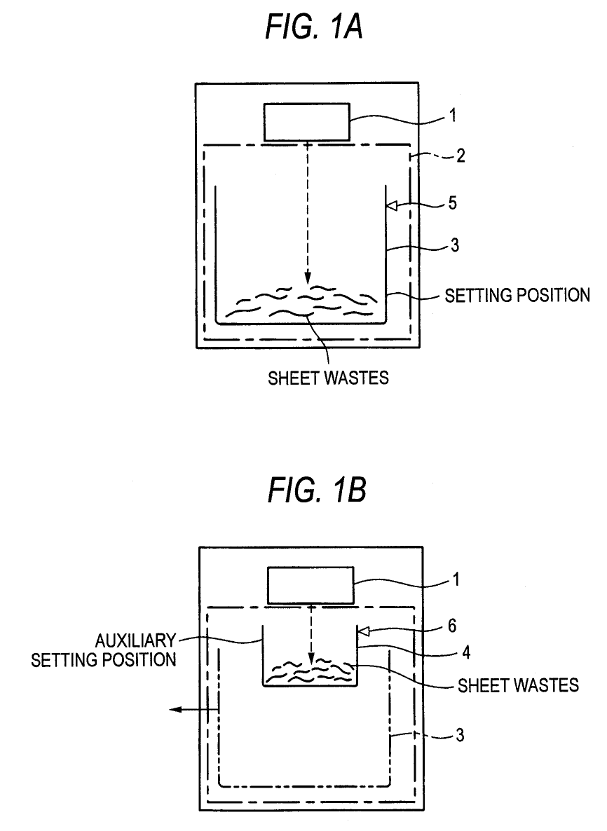

FIG. 2 is a view for explaining a printing device according to the first embodiment to which this invention is applied;

FIG. 3 is a view for explaining a digital copying machine according to the first embodiment;

FIGS. 4A and 4B are views for explaining a cutting device according to the first embodiment;

FIG. 5 is a view seen from the direction of arrow A in FIGS. 4A and 4B;

FIGS. 6A and 6B is a perspective view showing an auxiliary waste receiver according to the first embodiment;

FIGS. 7A and 7B are views for explaining a housing tray according to the first embodiment;

FIGS. 8A to 8C are views for explaining changes in a sheet bundle according to the first embodiment;

FIGS. 9A to 9C are views for explaining the appearance of sheet bundles in the housing tray according to the first embodiment;

FIGS. 10A to 10C are views for explaining the operation of an auxiliary waste receiver according to the first embodiment; and

FIGS. 11A and 11B are views for explaining the schematic configuration of a cutting device according to the second embodiment.

### DETAILED DESCRIPTION

On the basis of embodiments shown in the drawings attached herewith, a detailed explanation will be given of typical modes of this invention.

### Embodiment 1

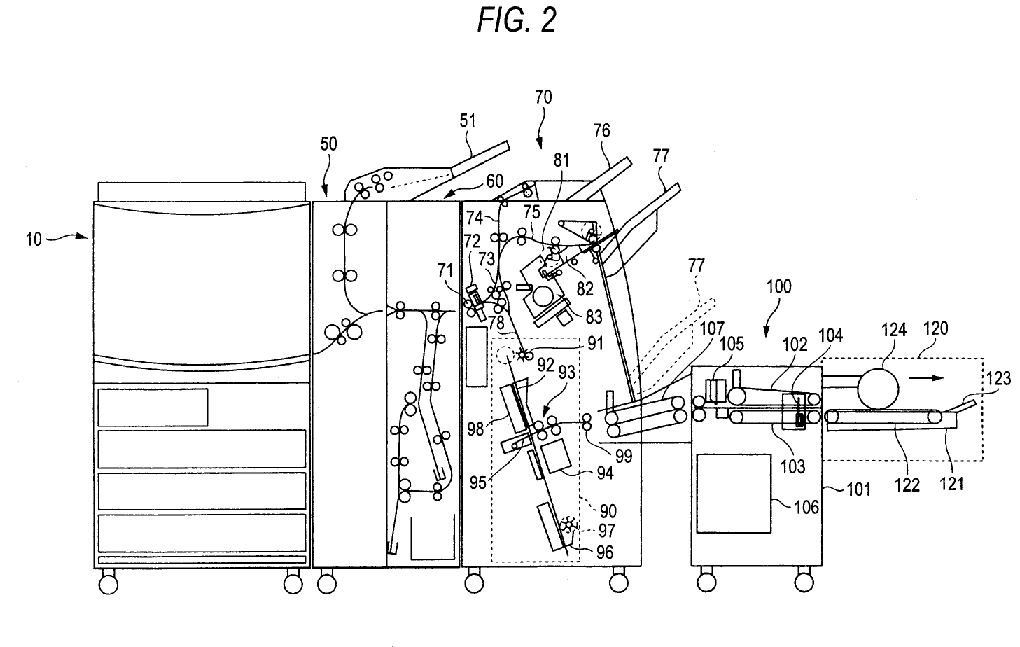

FIG. 2 shows a printing device serving as an image forming apparatus including a sheet waste processing device according to the first embodiment applied to this invention.

In FIG. 2, reference numeral 10 denotes a digital copying machine serving as the image forming apparatus. Images are formed on sheets by the digital copying machine 10. On the downstream side of the digital copying machine 10, combined therewith is a post-processing device 70 which executes post-processing such as binding processing, punching processing and center-binding/center-folding. Arranged between the digital copying machine 10 and the post-processing device 70 are an inverted-transporting device 50 for inverted-transporting each sheet and a sheet stand-by device 60 for causing plural sheets to stand by as the occasion demands.

Further, in this embodiment, arranged on the downstream side of the post-processing device 70 are a cutting device 100 for finish-cutting a bundle of sheets in a booklet form center-bound and center-folded by the post-processing device 70 and a housing tray 120 for housing the bundle of sheets (booklet) cut by the cutting device 100.

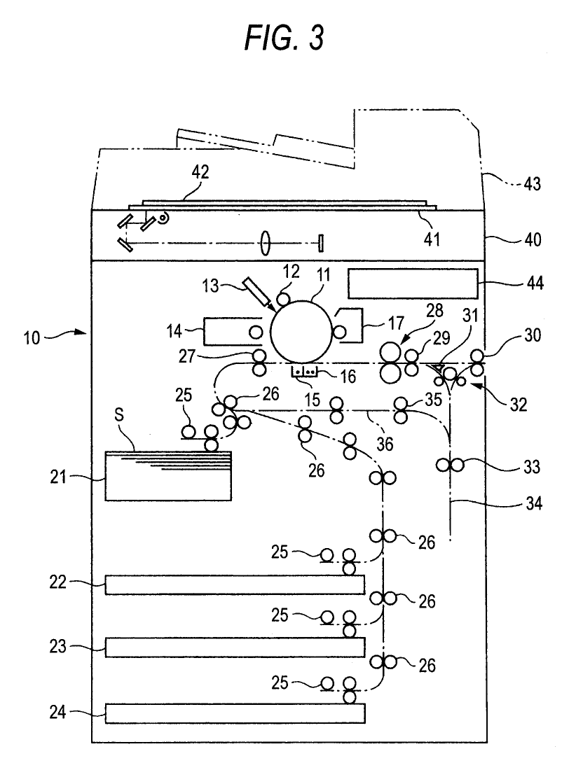

The digital copying machine 10 in this embodiment is configured as shown in FIG. 3. As seen from FIG. 3, on its upper side, the digital copying machine 10 includes an image reading device 40 for reading the image of a document 42 set on a platen glass 41. Beneath the image reading device 40, an image forming unit is provided. The image forming unit creates a toner image on a photosensitive body 11 and transfers the toner image thus created onto a sheet S transported by feeding roll 25 from plural sheet-feeding cassettes 21 to 24 arranged below the image forming unit.

Therefore, arranged around the photosensitive body 11 are a charger 12 such a charging roll for uniformly charging the photosensitive body 11, a light-exposing device 13 such as a laser scanner for forming a latent image on the photosensitive body 11 charged, a developing device 14 for visually imaging the latent image on the photosensitive body 11, a transferring device 15 such as a colotron for transferring the toner image created on the photosensitive body 11 onto the sheet S fed from each of the feeding cassettes 21 to 24 and a cleaner 17 for cleaning the toners remaining on the photosensitive body 11 after transfer. Reference numeral 16 denotes an ionizer for separating the sheet S after the toner image is transferred from the photosensitive body 11. Reference numeral 44 denotes an image information processing unit for processing the image information of the document 42 read by the image reading device 40. Reference numeral 43 indicated in two-dot chain line denotes an automated document feeding device, which is an optional device, for feeding the document 42 onto the platen glass 41.

Further, the sheet transporting system in this digital copying machine 10 is constructed as follows. In the vicinity of the sheet feeding cassettes 21 to 24, feeding rolls 25 for feeding the sheet S from each of the feeding cassettes 21 to 24 are provided. The sheet S fed by the feeding rolls 25 is transported by transporting rolls 26 arranged as required and guided to resist rolls 27 on the upstream side of the photosensitive body 11. The resist rolls 27 control the positioning of the sheet to transport, at a predetermined timing, the sheet to an area where the photosensitive body 11 and the transferring device 15 are opposite to each other.

The sheet subjected to transfer is transported to a fuser 28 in which the non-fixed toners on the sheet are fixed by e.g. heating and pressurizing. The sheet subjected to fixing is guided from exit roll 29 of the fuser 28 to ejecting roll 30 and transported to the device on the downstream side (inverted-transporting device 50 in this embodiment).

On the other hand, where images are to be created on both sides of the sheet, the sheet passed the exit roll 29 of the fuser 28 is changed downward in its transporting direction by an inverting gate 31 and guided to an inverted-transporting path 34 through a tri-roll 32 composed of three roles arranged in pressure-contact and inverting rolls 33. The sheet reached the inverted-transporting path 34 is transported to a return transporting path 36 with transporting rolls 35 by the inverting operation of the inverting rolls 33 under the condition that the rear end of the sheet is sandwiched by the inverting rolls 33. The sheet transported to the return transporting path 36 is given an image on the rear surface by the transferring device 15 via the resist rolls 27 and thereafter subjected to fixing by the fuser 28. The sheet subjected to the fixing is transported to the device on the downstream side via the exit roll 29 and ejecting roll 30.

In this way, the sheet with the image created by the digital copying machine 10, as shown in FIG. 2, is guided by the inverted-transporting device 50 or the sheet stand-by device 60 so that it is inverted-ejected to an ejecting tray 51 provided above or transported to the succeeding post-processing device at a predetermined timing by the sheet stand-by device 60.

The post-processing device 70 in this embodiment is provided with transporting rolls 71 for transporting the sheet fed from the sheet stand-by device 60 at the inlet and a puncher 72 for punching located immediately behind it. On the downstream side of the puncher 72, the sheet transporting path is branched. An upper sheet transporting path 73 is further branched into a sheet transporting path 74 along which the sheet, as it is, guided to an ejecting tray 76 provided above the post-processing device 70 and a sheet transporting path 75 along which the sheet after edge-bound is ejected to an offset catch tray 77. Therefore, the sheet transporting paths 73, 74 and 75 are appropriately provided with transporting rolls for sheet transportation and sensors, respectively.

Further, the sheets transported to the sheet transporting path 75 are lined up by a paddle 81 and a tamper 82 and thereafter bound in their sheet edges by a stapler 83 and ejected onto the offset catch tray 77. The offset catch tray 77 is adapted to automatically move downward as the number of the bundles of sheets increases.

On the other hand, a sheet transporting path 78 branched downward from the puncher 72 is provided with a center-binding processing device 90 for making a booklet composed of a plural sheets.

The center-binding processing device 90 is provided with a sheet aligning tray 92 slanted on the skew. On the upstream side thereof, paddle-equipped transporting rolls 91 located for transporting the sheet to the sheet aligning tray 92 is located. At the lower end of the sheet aligning tray 92, an end guide 96 for positioning the lower end (tip) of the sheet at a predetermined position is provided so that it can move along the vertical direction of the sheet aligning tray 92. Further, in the vicinity of the end guide 96, a paddle 97 for aligning the lower ends of the sheets is provided.

Further, at the upper end of the sheet aligning tray 92, a damper (not shown) for aligning the ends in the width direction of the sheets arranged on the sheet aligning tray 92 is provided. A damper driving unit 98 for driving the damper is provided.

Thus, the sheets transported from the sheet transporting path 78 to the center-binding processing device 90 are aligned every plural sheets by the sheet aligning tray 92 via the paddle-equipped transporting roll 91.

Further, the center binding processing device 90 is also provided with a center-binding saddle stapler 94 for center-binding a bundle of plural sheets lined up on the sheet aligning tray 92. Above the saddle stapler 94, a knife wedge 95 for center-folding the bundle of the plural sheets center-bound is movably provided oppositely to a pair of center-folding roll 93. Thus, by moving the end guide 96, the plural sheets lined up on the sheet aligning tray 92 are center-bound by the saddle stapler 94. By moving the knife wedge 95 toward the pair of the center-binding rolls 93, the sheet bundle center-folded is transported with the center fold being at the head from an ejecting roll 99 to the succeeding cutting device 100.

Further, in this embodiment, between the cutting device 100 and the post-processing device 70, belt transporters 107 circulating in a pair configuration are provided. The sheet bundle created as the booklet by the post processing device 70 is sandwich-transported by the belt transporter 107 and thereafter guided to a device body 101 of the cutting device 100. Within the device body 101 of the cutting device 100, transporting belts 102, 103 in the pair configuration for the sandwich-transporting the sheet bundle in the booklet form are provided as e.g. two sets of parallel belts in a direction nearly perpendicular to the transporting direction. Between the belts, a stopper 104 for positioning the tip (center fold of the booklet) is provided. The stopper 104 can advance or retreat, for example, from below for the sheet bundle transporting plane.

Therefore, after the sheet bundle in the booklet form which being sandwiched by the transporting belts 102, 103 is positioned by the stopper 104, it is cutting-finished in its rear end in such a manner that a knife 105 serving as a sheet processing tool located on the upstream side of the stopper 104 descends.

In this case, the sheet wastes generated owing to cutting by the knife 105 are received in a waste receiving box 106 which is a waste receiver mountably provided within the device body 101.

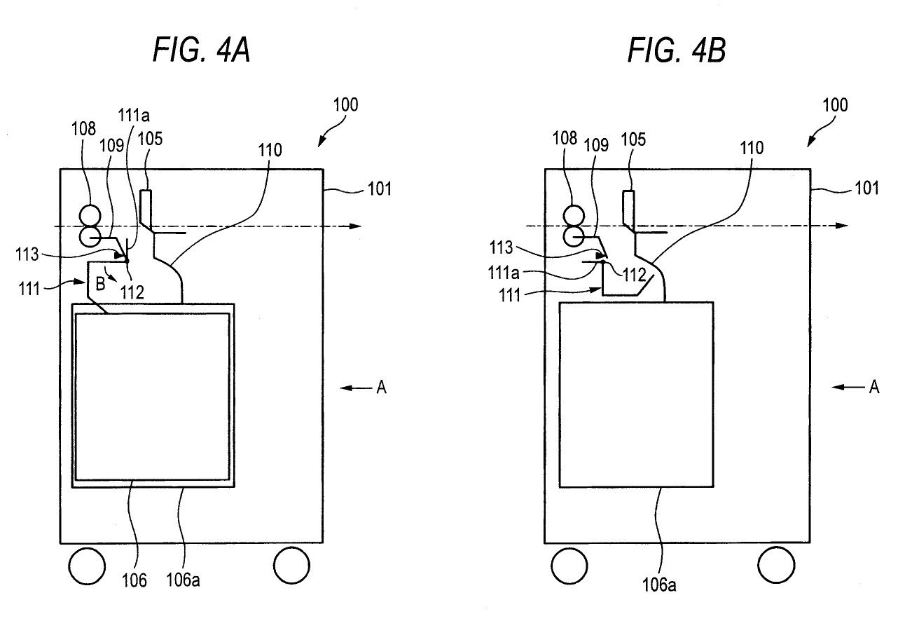

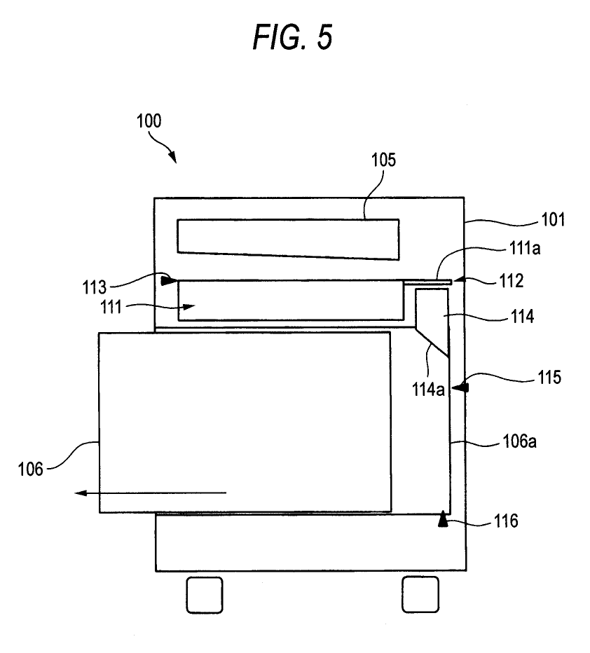

In particular, the cutting device 100 in this embodiment is structured as shown in FIGS. 4A and 4B. Now, FIG. 4A shows a stage in which the waste receiver 106 is mounted at a setting position within the device body 101. FIG. 4B is a stage in which the waste receiver 106 has been removed from the device body 101 (moved at a non-setting position). FIG. 5 is a view seen from the direction of an arrow A in FIGS. 4A and 4B. FIG. 5 shows the cutting device 100 in an intermediate stage between FIGS. 4A and 4B, i.e. the intermediate stage in the process in the waste receiver 106 is removed from the device body 101 (the stage moving from the setting position).

Within the device body 101 of the cutting device 100 in this embodiment, provided are inlet rolls 108 where the sheet bundle in the booklet form transported from the post processing device 70 side is transported into the device body 101. Between the inlet roll 108 and the knife 105, provided are guide members 109, 110 for guiding the sheet wastes generated owing to cutting by the knife 105 to the waste receiver 106. Thus, the sheet wastes generated when the sheet bundle is cut by the knife 105 are guided by the guide members 109, 110 so that they are received in the waste receiver 106.

The waste receiver 106 is provided so that it can be pulled out from a receiver 106a within the device body 101 (for example, in FIG. 4A, pulled out toward this side of the figure). Between the guide member 109 and the receiver 106a, an auxiliary waste receiver 111 serving as an auxiliary waste receiver in a vessel form is attached rotatably around a rotating shaft 112. The auxiliary waste receiver 111 suffers the rotating force in the direction of arrow B by an urging unit (not shown).

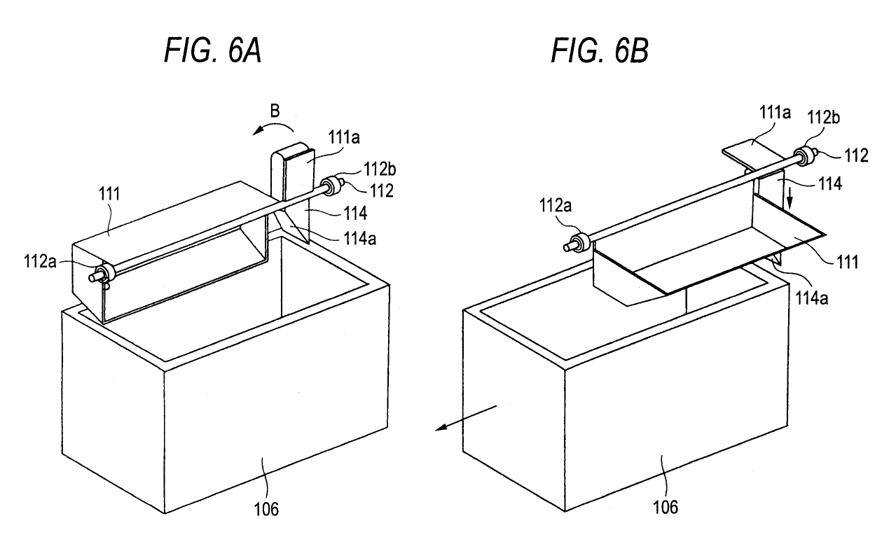

FIGS. 6A and 6B is a perspective view showing the moving state of the auxiliary waste receiver 111. FIG. 6A shows the state where the waste receiver 106 is mounted at the setting position and FIG. 6B shows the state where the waste receiver 106 has moved from the setting position.

As seen from FIGS. 6A and 6B in this embodiment, the rotating shaft 112 is provided with bearings 112a, 112b mounted at its both ends, and so is freely movable by these bearings 112a, 112b. The rotating shaft 112 is also provided with an arm 111a extending in a direction different from the auxiliary waste receiver 111 at a position different from that of the auxiliary waste receiver 111. The arm 111a is located nearly above in the state where the waste receiver 106 is mounted at the setting position within the device body 101. Further, in the vicinity of the arm 111a, a slide piece 114 vertically movable within the device body 101 is provided. The slide piece 114 partially has a slope 114a for vertically moving the slide piece 114 while the waste receiver 106 moves between the setting position and the non-setting position. Therefore, when the waste receiver 106 is to be mounted at the setting position, the slope 114a starts to come in contact with the waste receiver 106. Further, when the slope 114a climbs up on the waste receiver 106, the slide piece 114 gradually moves upward so that the arm 111a is moved in a direction opposite to the direction of arrow B. On the other hand, when the waste receiver 106 moves from the setting position, the slide piece 114 moves downward so that the arm 111a is rotated in the direction of arrow B. In short, by ascend/descent of the slide piece 114, the arm 111a of the auxiliary waste receiver 111 is swung. As a result, for example, as shown in FIG. 6B, the auxiliary waste receiver 111 is located at an auxiliary setting position, thereby permitting the sheet wastes to be received. In FIG. 4, reference numeral 113 denotes an auxiliary sensor for detecting the permissible quantity of the sheet wastes within the auxiliary waste receiver 111. In FIG. 5, reference numeral 115 denotes a main sensor for detecting the permissible quantity of the sheet wastes within the waste receiver 106. Reference numeral 116 denotes a position sensor for detecting whether or not the waste receiver 106 is located at the setting position.

Further, in this embodiment, as shown in FIG. 2, on the downstream side of the cutting device 100, a housing tray 120 for housing sheet bundles in the booklet form cutting-finished is provided so as to project nearly horizontally from the one side of the cutting device 100.

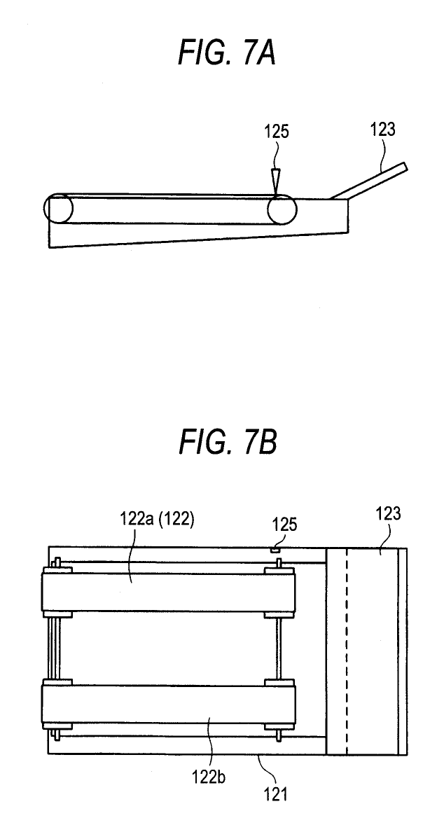

In the housing tray 120, as shown in FIGS. 7A and 7B, two sheet bundle transporting belts 122 (122a, 122b) rotatably for a supporting frame 121 are arranged in nearly parallel so as to constitute a transporting plane (along which the sheet bundle in the booklet form is transported) projecting upward from the supporting frame 121. At the tip side (downstream side in the transporting direction) of the supporting frame 121, a slope 123 is provided which projects in a rearward sloped state from the supporting frame 121. At the slope 123, the sheet bundle transported by the sheet bundle transporting belts 122 is stopped and stacked thereon. Further, in the vicinity of the end on the downstream side of the sheet bundle transporting belts 122 at the upper position of the supporting frame 121, a full stack sensor 125 is provided for detecting the fully stacked state of the sheet bundles stacked and received by the slope 123. Furthermore, as shown in FIG. 2, above the sheet bundle transporting belts 122, a depressing member 124 is provided for depressing the sheet bundle transported on the sheet transporting belts 122.

In this embodiment, the sheet transporting belts 122 of the accommodating tray 120 are drive-controlled so that the sheets bundles ejected onto the sheet bundle transporting belts 122 from the cutting device 100 are successively stacked.

An explanation will be given of the operation of the printing device having the structure as described above, mainly of the processed state of the sheets after the post-processing device 70.

In this embodiment, as shown in FIG. 2, the sheet with the image created by the digital copying machine 10 is transported to the post-processing device 70 via the inverted-transporting device 50 and sheet stand-by device 60. The sheet passed through the sheet transporting path 78 of the post-processing device 70 is transported to a center-binding device 90. The bundle of sheets aligned is center-bound and center-folded. The sheet bundle folded is transported with the fold being at the head from the ejecting roll 99 to the succeeding cutting device 100 via the belt transporting body 107.

In the cutting device 100, with the fold of the sheet bundle being positioned by the stopper 104, the sheet bundle is cut by the knife 105 so that it is cutting-finished to have a predetermined length.

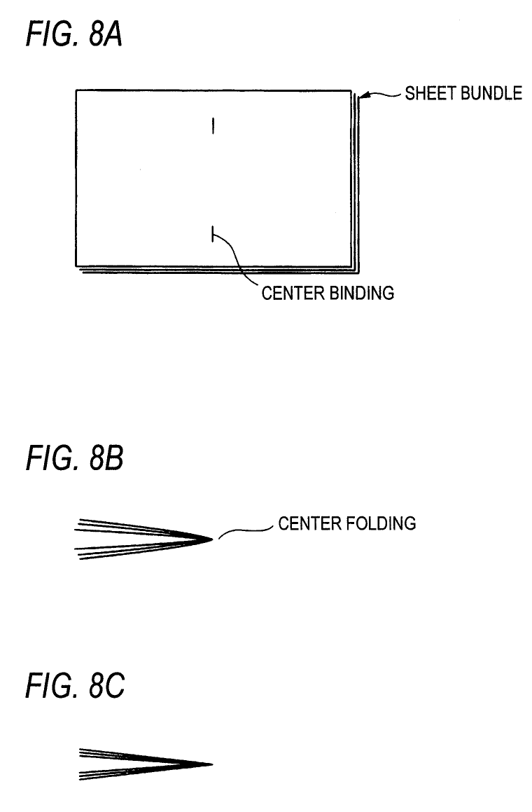

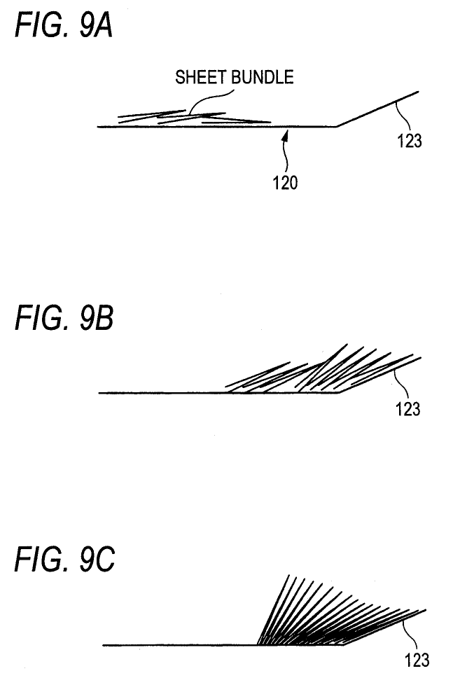

The sheets in such a process until the cutting change as shown in FIGS. 8A to 8C. Specifically, as shown in FIG. 8A, the plural sheets aligned become the sheet bundle center-bound in the post-processing device 70. The sheet bundle center-folded within the same post-processing device 70 becomes the shape as shown in FIG. 8B. At this time, the length of the sheet bundle folded is different between its internal side and the external side (surface side). So, the lengths at the end of the sheet bundle at the center-folded stage is not uniform. By cutting-finishing the non-uniform portion using the cutting device 100, the finished state with the lengths at the end aligned can be obtained as shown in FIG. 9C.

The sheet bundles cutting-finished by the cutting device 100 are successively ejected to the housing tray 120. In this case, since the sheet bundle transporting belts 122 of the housing tray 120 are drive-controlled so as to move at a predetermined timing, the sheet bundle on the sheet bundle transporting belts 122 are ejected so that a succeeding sheet bundle is stacked on at a part of the sheet bundle earlier ejected. The sheet bundles stacked are successively transported toward the slope 123 by the transporting force of the sheet bundle transporting belts 122. The sheet bundles are successively dammed by the slope 123 so that the succeeding sheet bundles are stacked in their raised state. When the sheet bundles exceed the full stack sensor 125, housing of the sheet bundles into the housing tray 120 is stopped.

FIGS. 9A to 9C show the stacked state of the sheet bundles in the housing tray 120. As shown in FIG. 9A, as regards the sheet bundles on the housing tray 120, the succeeding sheet bundle are partially stacked on the preceding sheet bundle. The sheet bundles successively stacked, as they are, are transported toward the slope 123 within the housing tray 120. When the sheet bundle at the head reaches the slope 123, since the slope 123 is angled at a predetermined angle, the sheet bundle suffers the transporting force given by the sheet bundle transporting belts 122 and friction force at the area with the sheet bundle itself come in contact. Thus, the sheet bundles slide on the slope 123 and are aligned with their fold oriented upward. The succeeding sheet bundle is also influenced by the preceding sheet bundle so that the sheet bundles are lined up in a direction standing with their fold oriented upward. Thus, the sheet bundles successively lined up as shown from FIG. 9B to FIG. 9C. When it is detected by the full stack sensor 125 (see FIG. 7) that the sheet bundles are fully stacked on the housing tray 120, a message display may be made by for example an operation unit of the digital copying machine 10 so that an operator is urged to take out the sheet bundles lined up from the housing tray 120.

A detailed explanation will be given of particularly the method of processing sheet wastes in the cutting device 100 amid the above operation.

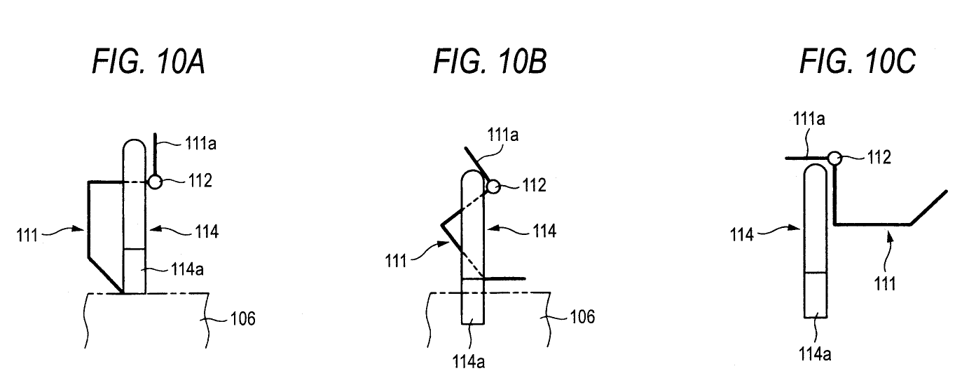

FIGS. 10A to 10C are schematic views showing the sheet waste processing method within the cutting device 100 according to this embodiment, and particularly show the operation of the auxiliary waste receiver 111. In FIG. 10A, since the waste receiver 106 (indicated in two-dot chain line) is mounted at the setting position, the lower end of the slide piece 114 is lifted by the waste receiver 106. The upper side of the slide piece 114 lifted pushes the arm 111a of the auxiliary waste receiver 111 rightward in the figure around the rotating shaft 112. Therefore, the auxiliary waste receiver 111 cannot house the sheet wastes and the entire quantity of the sheet wastes is received in the waste receiver 106.

FIG. 10B shows the intermediate state in which the waste receiver 106 is being pulled out and the slide piece 114 starts to descend. The arm 111a of the auxiliary waste receiver 111 has been suppressed by the slide piece 114 starts to rotate around the rotating shaft 112. Therefore, the auxiliary waste receiver 111 is being deformed so that it can house the sheet wastes.

In the state of FIG. 10C, the waste receiver 106 has been removed and the slide piece 114 is correspondingly located at the lower position. Therefore, the arm 111a of the auxiliary 111 ceases rotating around the rotating shaft 112. Thus, the auxiliary waste receiver 111 is located at the auxiliary setting position so that it can house the sheet wastes in place of the waste receiver 106.

Further, in this embodiment, as shown in FIGS. 4 and 5, the permissible quantities of the sheet wastes within the waste receiver 106 and auxiliary waste receiver 111 are detected by the sensors. So, at the stage where the sheet wastes within the waste receiver 106 have increased in quantity, the main sensor 115 for the waste receiver 106 can urge the operator to dispose of the sheet wastes. Further, in the state where the waste receiver 106 has been removed to dispose of the sheet wastes therein (moved at the non-setting position) but is not still moved to the setting position, if the sheet wastes within the auxiliary waste receiver 111 reaches the permissible quantity, the cutting device 100 is stopped with the aid of the auxiliary sensor 113. As a result, the sheet wastes do not overflow into the cutting device 100.

Further, in this embodiment, where the waste receiver 106 once removed from the device body 101 is mounted at the setting position, the operation going from FIG. 9A to FIG. 9C is done so that the sheet wastes collected in the auxiliary waste receiver 111 fall into the waste receiver 106. Thus, it is not necessary to dispose of the sheet wastes within the auxiliary waste receiver 111 aside from the waste receiver 106. As a result, only the sheet wastes within the waste receiver 106 may be disposed of.

As understood from the description hitherto made, in this embodiment, the sheet wastes in the cutting device 100 may be disposed of in such a manner that the sheet wastes received in the waste receiver 106 are disposed of. In addition, even when the waste receiver 106 has been removed, the sheet wastes can be received in the auxiliary waste receiver 111. Thus, it is necessary to stop the operation of the cutting device 100, thereby improving the productivity. Further, since the sheet wastes can be appropriately disposed of from the waste receiver 106, it is not necessary to unnecessarily upsize the waste receiver 106, thereby downsizing the cutting device 100.

This embodiment proposed a manner of moving the auxiliary waste receiver 111 by rotation to a position where the sheet wastes can be housed. Without being limited to such a manner, by using a motor for example, a configuration may be adopted in which the auxiliary waste receiver 111 is moved between an auxiliary setting position where the sheet wastes can be housed and a retreating position.

Further, in this embodiment, the waste receiving box 106 may be formed, for example, in a double structure as long as the sheet wastes can be disposed of. The waste receiver may be a rigid vessel made of e.g. resin, or may be a film-like sack.

Further, in this embodiment, under the condition that the waste receiving box 106 has been moved from the setting position, the auxiliary waste receiver 111 has only to be capable of housing the sheet wastes in place of the waste receiving box 106. For example, the auxiliary waste receiver 111 may be formed of a single member. The auxiliary waste receiver 111 may be formed by moving plural members to be unified. Further, the waste receiving box 106 and the auxiliary waste receiver 111 may be located on e.g. a turn table so that they can house at the setting position and auxiliary setting position located at the same position, respectively.

Further, in this embodiment, a concrete embodiment of the sheet processing device according to this invention may be a puncher, stapler, etc. which generates sheet wastes. However, from the standpoint of generating a large quantity of the sheet wastes, preferably, it is cutting machine which generates the sheet wastes by the cutter for cutting sheets. In this case, the cutter may be e.g. a guillotine cutter or circle cutter.

Further, in this embodiment, the sheet processing device was applied to processing of the sheet wastes in the cutting device 100. It is needless to say that this configuration may be applied to processing in the sheet processing tools such as a punching device.

Further, in this embodiment, the digital copying machine 10 was employed as the image forming unit. Without being limited to it, a printer may be employed. In this embodiment, although a monochromatic image was created by the digital copying machine 10, it is needless to say that a color image may be created.

### Embodiment 2

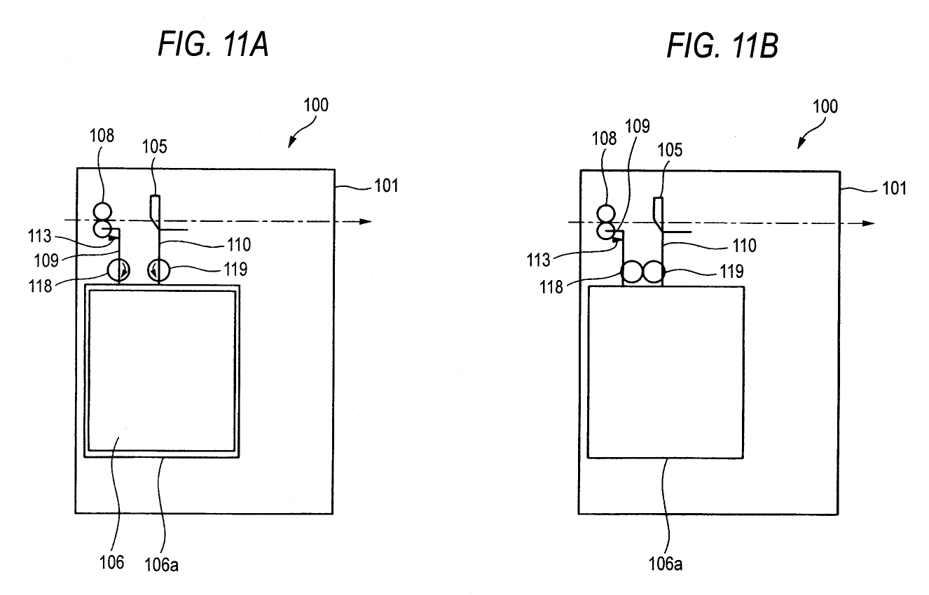

FIGS. 11A and 11B show a cutting device 100 according to the second embodiment to which this invention is applied. The cutting device 100 according this embodiment has nearly the same configuration as the first embodiment, but is different from the first embodiment in that this embodiment is not provided with the auxiliary waste receiver according to the first embodiment, but a substitute member. Incidentally, in this embodiment, like reference numerals referring to like elements in the first embodiment will not be explained in detail.

The cutting device 100 according to this embodiment is provided with a pair of roll members 118, 119 attached to the lower part of the two guide members 109, 110 below the knife 105. These roll members 118, 119, when the waste receiver 106 is mounted in a receiver 106a as shown in FIG. 11A, are kept in a state where the distance therebetween is extended. Thus, by the rotation of the roll members 118, 119, the sheet wastes are easily transported to the waste receiver 106.

As shown in FIG. 11B, when the waste receiver 106 is removed, the roll members 118, 119 come near to or in contact with each other so that the space therebetween is lost. Thus, the two guide members 109, 110 and the two roll members 118, 119 make the auxiliary waste receiver above the receiver 106a.

Further, at the stage when the waste receiver 106 is mounted, if the two roll members 118, 119 leave each other, the sheet wastes received in this space will be received into the waste receiver 106 located below. Thus, the sheet wastes generated can be disposed of from the waste receiving box 106.

In this embodiment, the waste housing was constructed by moving the two members 118, 119 in a pair. However, also using belt members in place of the roll members, the sheet wastes can be preferably transported. Further, by forming a protrusion on the surface of the roll member, transportation of the sheet wastes can be improved.

Further, in this embodiment, the configuration in which the two members are moved was proposed. However, only one member may be moved. The member, even if it does not move, may employed as long as it constitutes the waste housing by movement. Further, it is needless to say that the waste receiver can take any shape as long as it can house the sheet wastes.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A sheet processing device comprising:
a sheet processing tool that generates piece-like sheet wastes by processing for sheets; and
a sheet waste receiving device that receives sheet wastes generated by the sheet processing tool, the sheet waste receiving device including:
a waste receiver that is provided freely movably between a setting position where the sheet wastes are received and a non-setting position where the sheet wastes received at the setting position are disposed of; and
an auxiliary waste receiver that is located at an auxiliary setting position where the sheet wastes is received in place of the waste receiver under the condition that the waste receiver has been moved from the setting position, and the auxiliary waste receiver retreats from the auxiliary setting position under the condition that the waste receiver is located at the setting position.

2. The sheet processing device as claimed in claim 1, further comprising:
a switching mechanism that moves the auxiliary waste receiver to the auxiliary setting position simultaneously in a case where the waste receiver moves from the setting position to the non-setting position, and that causes the auxiliary waste receiver to retreat from the auxiliary setting position simultaneously in a case where the waste receiver moves from the non-setting position to the setting position.

3. The sheet processing device as claimed in claim 2, wherein the switching mechanism causes the sheet wastes received in the auxiliary waste receiver into the waste receiver in a case where the auxiliary waste receiver retreats from the auxiliary setting position.

4. The sheet processing device as claimed in claim 2, wherein under the condition that the auxiliary waste receiver moves to the auxiliary setting position, the auxiliary waste receiver blocks direct touching the sheet processing tool from the direction of the setting position of the waste receiver.

5. The sheet processing device as claimed in claim 1, further comprising:
a detecting unit that detects a permissible receiving quantity of the sheet wastes in the waste receiver;
an notifying unit that notifies an operator; and
a processing control unit that urges the operator to dispose of the sheet wastes from the waste receiver by the notifying unit on the basis of the detected information from the detecting unit, and that stops the operation of the sheet processing tool when the waste in the waste receiver reaches a predetermined permissible quantity.

6. The sheet processing device as claimed in claim 1, further comprising:
a notifying unit that gives a notice urging an operator to move the waste receiver to the setting position; and
a processing control unit that stops the operation of the sheet processing tool when the waste in the auxiliary waste receiver reaches a predetermined permissible quantity.

7. The sheet processing device as claimed in claim 5, wherein the processing control unit notifies the operator of permissible processing contents using the notifying unit until the quantity of the sheet wastes generated after notifying reaches the predetermined permissible quantity.

8. The sheet processing device as claimed in claim 6, wherein the processing control unit notifies the operator of permissible processing contents using the notifying unit until the quantity of the sheet wastes generated after notifying reaches the predetermined permissible quantity.

9. The sheet processing device as claimed claim 1, further comprising:
an auxiliary detecting unit that detects a permissible housing quantity of the sheet wastes in the auxiliary waste receiver;
a notifying unit that notifies an operator; and
a processing control unit that, on the basis of the detected information from the auxiliary detecting unit, urges an operator to move the waste receiver to the setting position, and that stops generation of the sheet wastes in the sheet processing tool.

10. The sheet processing device as claimed in claim 1, wherein the sheet processing tool comprises a cutter cutting the sheets.

11. An image forming apparatus comprising:
an image forming unit that forms images on sheets; and
a sheet processing device according to claim 1 that processes the sheets with the images formed thereon.

12. The sheet processing method comprising:
generating piece-like sheet wastes by a sheet processing tool;
receiving the generated sheet wastes in generating of the piece-like sheet wastes; and
retreating from an auxiliary setting position where the sheet wastes is received in place of the waste receiver under the condition that the waste receiver is moved from the setting position, under the condition that the waste receiver is located at the setting position by the auxiliary waste receiver located at the auxiliary setting position.
